(19) United States
(12) Patent Application Publication
(10) Pub. No.: US 2025/0231461 A1
(43) Pub. Date: Jul. 17, 2025

(54) ON-CHIP PHOTONIC SYSTEM FOR SEQUENTIAL PHOTON ENTANGLEMENT

(71) Applicant: Cisco Technology, Inc., San Jose, CA (US)

(72) Inventors: Sujit Handanhal Ramachandra, San Jose, CA (US); D. Brice Achkir, Livermore, CA (US); Vipulkumar K. Patel, Breinigsville, PA (US)

(21) Appl. No.: 18/413,465

(22) Filed: Jan. 16, 2024

(51) Int. Cl. G02F 3/00; G06N 10/20

(52) U.S. Cl. CPC G02F 3/00; G06N 10/20

(57) ABSTRACT

In some aspects, the techniques described herein relate to an apparatus including: a pluggable optical module including a shell; and a photonic integrated circuit arranged within the shell, the photonic integrated circuit including: a quantum entangler; a plurality of single photon sources; and a plurality of switches.

### TECHNICAL FIELD

The present disclosure relates to quantum entanglement of photons.

### BACKGROUND

On-chip photonic systems for sequential photon entanglement are desirable for a variety of applications, such as quantum computing, quantum networks, quantum error correction, and quantum sensing, among others. Specifically, sequential photon entanglement may be used to generate Greenberger-Horne-Zeilinger (GHZ) states and quantum cluster states used in numerous quantum computing applications. The ability to generate such states on-demand is a step on the path to implementing scalable quantum networks.

### BRIEF DESCRIPTION OF THE DRAWINGS

FIG. 1 is a photonic integrated circuit configured to implement the on-chip sequential photon entanglement techniques of this disclosure, according to an example embodiment.

FIG. 2 is a thermally tuned switch that may be used in implementations of the disclosed on-chip sequential photon entanglement techniques, according to an example embodiment.

FIG. 3 is an on-chip quantum entangler that may be used in implementations of the disclosed on-chip sequential photon entanglement techniques, according to an example embodiment.

FIG. 4A is a perspective view of a Quad Small Form Factor Pluggable Double Density (QSFP-DD) optical module that may be used in the disclosed on-chip sequential photon entanglement techniques, according to an example embodiment.

FIG. 4B is an exploded view of the internal components of a QSFP-DD optical module that may be used in the disclosed on-chip sequential photon entanglement techniques, according to an example embodiment.

FIG. 5 is flowchart providing a first example method that may be used to implement the disclosed on-chip sequential photon entanglement techniques, according to an example embodiment.

FIG. 6 is flowchart providing a second example method that may be used to implement the disclosed on-chip sequential photon entanglement techniques, according to an example embodiment.

FIG. 7 illustrates a hardware block diagram of a computing device configured to implement the disclosed on-chip sequential photon entanglement techniques, according to an example embodiment.

### DETAILED DESCRIPTION

### Overview

In some aspects, the techniques described herein relate to an apparatus including: a pluggable optical module including a shell; and a photonic integrated circuit arranged within the shell, the photonic integrated circuit including: a quantum entangler, a plurality of single photon sources, and a plurality of switches.

In some aspects, the techniques described herein relate to an apparatus including: a polarization rotator formed in a photonic integrated circuit; a polarization beam splitter formed in the photonic integrated circuit; and an optical delay line formed in the photonic integrated circuit, wherein: the polarization rotator sequentially provides single photons to the polarization beam splitter with polarization diagonal to a transmission polarization of the polarization beam splitter; the optical delay line obtains the single photons from the polarization beam splitter through a cross port of the polarization beam splitter and returns the single photons to the polarization beam splitter; and the polarization beam splitter sequentially entangles single photons obtained concurrently from the polarization rotator and the optical delay line.

In some aspects, the techniques described herein relate to a method including: providing, to a photonic integrated circuit, input laser radiation; routing, via a network of switches formed in the photonic integrated circuit, the input laser radiation to a plurality of single photon sources formed in the photonic integrated circuit; emitting, from the plurality of single photon sources, a plurality of single photons; multiplexing, via a plurality of cascaded y-splitters formed in the photonic integrated circuit, the plurality of single photons to a quantum entangler formed in the photonic integrated circuit; entangling the plurality of single photons using the quantum entangler; and providing the entangled single photons from the photonic integrated circuit.

### Example Embodiments

A scalable, complementary metal-oxide-semiconductor (CMOS) process compatible system that can deterministically generate single photons and entangle them to generate higher order Greenberger-Horne-Zeilinger (GHZ) and linear quantum cluster states may be beneficial to certain quantum computing applications. Such a system may include predictably addressing, controlling and protecting systems of entangled photons against decoherence.

At the time of filing of this disclosure, related art techniques for generating a cascade of entangled photons using single photon sources and entanglers may be found unsatisfactory for many applications due to:
The probabilistic nature of the light sources used: Many implementations use Spontaneous Parametric Down Conversion (SPDC) to generate single photons. It is difficult to setup networking protocols with such probabilistic sources due to reduced photon entanglement efficiency resulting in difficulties in scaling up to provide larger entangled states. Accordingly, such techniques present timing issue for GHZ state generation owing to their probabilistic nature. These techniques are also complex to set-up and are costly.
Challenges in integration: Sources such as quantum dots are resource efficient. The generation rates for quantum dots, however, are low and integration with conventional CMOS silicon optical process flows is challenging.
Lack of scalability: Many solutions are implemented using free space optical components and general-purpose Field Programmable Gate Arrays (FPGAs). Such solutions are difficult to scale commercially.

At the time of filing of this disclosure, the innovators are not aware of any related art scalable, on chip photonic systems that generate higher order entangled photons (e.g., GHZ states, Cluster states) deterministically.

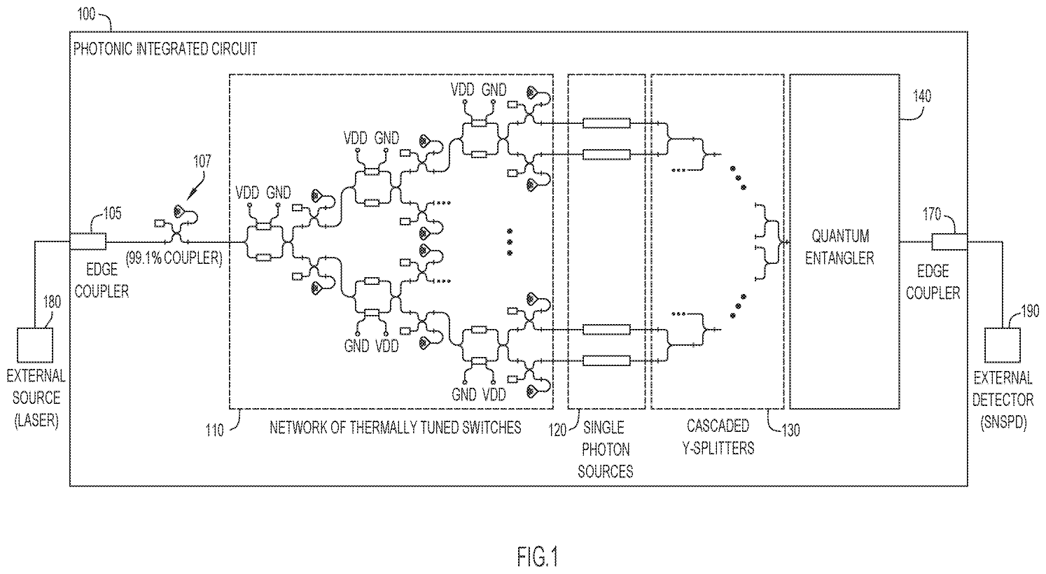

With reference now made to FIG. 1, depicted therein is a photonic integrated circuit 100 configured to provide sequential entangled photons. The photonic integrated circuit 100 includes an input edge coupler 105, a 99%-1% coupler 107, a network of switches 110, single photon sources 120, cascaded y-splitters 130, an integrated circuit quantum entangler 140, and an output edge coupler 170. Broadly speaking, the input edge coupler 105, the 99%-1% coupler 107 and the network of switches 110 rout energy from the external laser source to sequentially excite the single photon sources 120. According to some specific examples, the single photon sources 120 are constructed “on-chip” on photonic integrated circuit 100 as rare-earth-doped TiO₂ or Al₂O₃ individual ion-addressable single photon light sources. Such individual ion-addressable single light photon light sources may be formed using a standard CMOS process flow. For example, such single photon light sources may be constructed by depositing TiO₂ or Al₂O₃ on a Silicon waveguide which is patterned into a photonic crystal.

The photons outputted by the single photon sources 120 are provided to the cascaded y-splitters 130. The cascaded y-splitters 130 are structured as low-loss y-splitters that receive the single photon outputs from the single photon sources 120 and combine them into quantum entangler 140. Quantum entangler 140 is configured to sequentially entangle the received photons, outputting the now entangled photons to an external device 190 via output edge coupler 170. The external device 190 may be embodied as a device that consumes entangled photons, such as a superconducting nanowire single-photon detector (SNSPD).

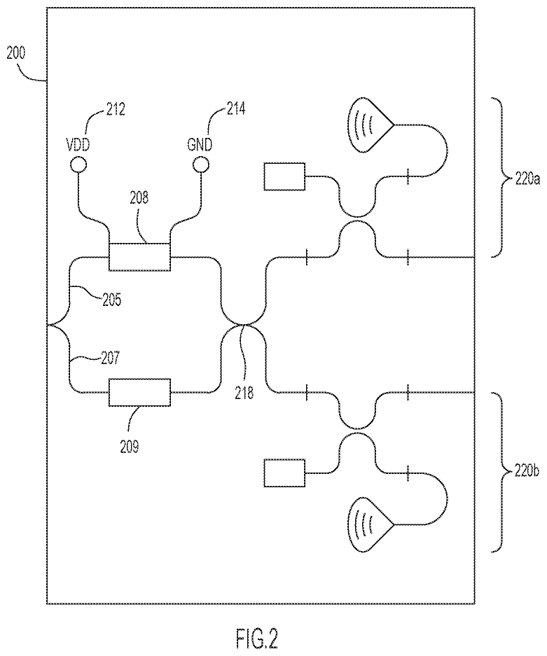

Turning to FIG. 2, depicted therein is a thermally tuned switch 200, which is one example of a type of switch that may be used in the network of switches 110 of FIG. 1. Thermally tuned switch 200 is implemented as 1 or 2 phase shifters in a Mach-Zehnder Interferometer (MZI) configuration. Thermally tuned switch 200 includes two waveguide arms 205 and 207. Waveguide arm 205 includes a heater 208 and waveguide arm 207 includes a phase shifter 209. Heater 208 includes a voltage terminal 212 and a ground terminal 214. When an electrical current is driven through the heater 208 via the voltage terminal 212, the dissipated power increases the local temperature around arm 205, shifting the effective index of the waveguide modes. This change to the effective index changes the phase of the light propagating through one of the arms by a different amount as compared to the other arm (since the two arms now have different effective indices owing to heating of arm 205). The light from waveguide arm 205 and waveguide arm 207 interferes at the output 218, and depending on the phase relationship (controlled by the current input), the output amplitude of the thermally tuned switch 200 can be controlled. Each of waveguide arm 205 and waveguide arm 207 is constructed with a respective directional 99%-1% coupler 220a/220b. The directional couplers 220a and 220b may be used to monitor the output of the thermally tuned switch 200 for use in a feedback loop to control the current through the heater 208.

Thermally tuned switches, like thermally tuned switch 200, are just one example of the types of switches that may be used in the network of switches 110 of FIG. 1. For example, electro-optic switches or any other switch known to the skilled artisan may be used in place of thermally tuned switch 200, so long as the switch offers sufficiently low loss performance. An electro-optic switch would look similar to thermally tuned switch 200 but with doped waveguides instead of the regular waveguides and electrodes connected directly to the waveguides to control the electric field within. Electro-optic switches use the plasma dispersion effect to change the effective index of the waveguide mode based on the applied voltage, thereby changing the electric field within the waveguide.

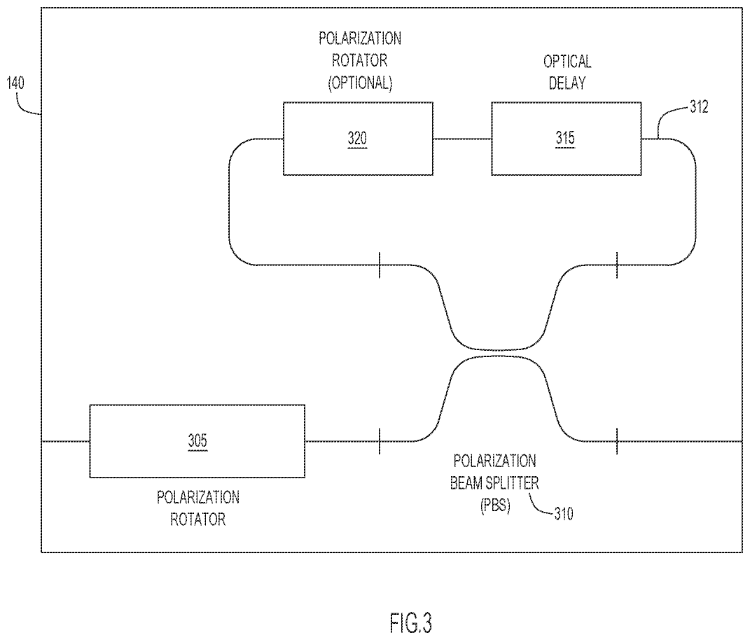

Turning to FIG. 3, depicted therein is an example quantum entangler 140, which includes a polarization rotator 305, a polarization beam splitter 310, an optical delay line 312 that includes an optical delay 315, and in some examples, a polarization rotator 320. Speaking broadly, a photon enters the polarization rotator 305 from cascaded y-splitters 130 illustrated in FIG. 1. The polarization rotator 305 gives the photon diagonal polarization. The now diagonally polarized photon enters polarization beam splitter 310. Polarization beam splitter 310 may be embodied as a low-loss on-chip polarization beam splitter which, as described below, serves to entangle the photons received at the quantum entangler 140.

If the current photon is the first photon, it exits polarization beam splitter 310 through the cross port into optical delay line 312. Optical delay line 312 acts a photonic memory so that the current photon can be entangled with the next photon received by quantum entangler 140. Specifically, optical delay line 312 and optical delay 315 ensure that the current photon re-enters the polarization beam splitter 310 at the same time as the next photon to be received from the cascaded y-splitters of FIG. 1. Polarization rotator 320 may be included in quantum entangler 140 to compensate for arbitrary polarization shifts introduced to the photon.

Now describing the entanglement with more detail, polarization rotator 305 sets the initial polarization of a received photon to be diagonal to the transmission polarization of the polarization beam splitter 310. This results in a photon polarization state of:

$$\vert p 〉 = \frac{1}{\sqrt{2}} ( \vert h 〉 + \vert v 〉 ) , \qquad ( 1 )$$

where |h [symbol] is horizontal polarization (i.e., transverse electric polarization (TE)) and |v [symbol] is vertical polarization (i.e., transverse magnetic polarization (TM). Once the photon exits through a port of the polarization beam splitter 310, it is in a spatial superposition of being transmitted as the |h [symbol] polarization state and reflected as the Iv [symbol] polarization state.

If the first photon enters the cross port of the polarization beam splitter 310 (there may be instances where it exits the through port), the entanglement with a second received photon proceeds. Specifically, the first photon enters the cross port of the polarization beam splitter 310 and propagates through low-loss optical delay line 312, which serves as a photonic memory. Optical delay 315 ensures that the first photon returns to the polarization beam splitter 310 at the same time that the next photon is obtained from polarization rotator 305. The optional polarization rotator 320 may be added to compensate for random polarization shifts along the passive optical path, which can be pre-characterized.

A second photon generated from one of the single photon sources 120 of FIG. 1 is timed to be generated such that it reaches the first input port of polarization beam splitter 310 at the same time that the first photon reaches the cross port of the polarization beam splitter 310. The first and second photons pass through the polarization beam splitter 310 and emerge as two photons entangled with one another. The two photons with diagonal polarization are now in the following entangled state:

$${\vert p 〉 ⊗ \vert p 〉 \to \vert ϕ 〉}^{+} = \frac{1}{\sqrt{2}} ( \vert {h}_{1} {h}_{2} 〉 + \vert {v}_{1} {v}_{2} 〉 ) , \qquad ( 2 )$$

where the subscripts indicate photon detection times.

Once the two photons are entangled, the first photon is coupled out of the through port of the polarization beam splitter 310 while the second photon is coupled out at the cross port. This entangled state may be verified by detecting the first photon and subsequently detecting the second photon later in time after one or more entanglement cycles.

The first photon may proceed off of the photonic integrated circuit 100 via output edge coupler 170 (both illustrated in FIG. 1) into a quantum network. The second photon enters optical delay line 312, propagates through it, and entangles with a third photon coming in from the single photon sources 120 via cascaded y-splitters 130 (also illustrated in FIG. 1). The entanglement of the second photon with the third photon results in a three-photon GHZ state due to the second photon being previously entangled with the first photon. The three photon GHZ state can be mathematically represented as follows:

$$\vert {Ψ}_{GHZ}^{3} 〉 = \frac{1}{\sqrt{2}} ( \vert {p}_{1} {h}_{2} {p}_{3} 〉 + \vert {m}_{1} {v}_{2} {m}_{3} 〉 ) , \qquad ( 3 )$$

where

$$\vert m 〉 = \frac{1}{\sqrt{2}} ( \vert h 〉 - \vert v 〉 )$$

is the antidiagonal state.

The process may then repeat with a fourth photon, resulting in the following 4-photon linear cluster state:

$$\vert {Ψ}_{LC}^{4} 〉 = \frac{1}{2} ( \vert {p}_{1} {h}_{2} {h}_{3} {p}_{4} 〉 + \vert {p}_{1} {h}_{2} {v}_{3} {m}_{4} 〉 + \vert {m}_{1} {v}_{2} {h}_{3} {p}_{4} 〉 - \vert {m}_{1} {v}_{2} {v}_{3} {m}_{4} 〉 ) . \qquad ( 4 )$$

Increasingly higher order linear cluster states can be obtained as more photons are sequentially entangled.

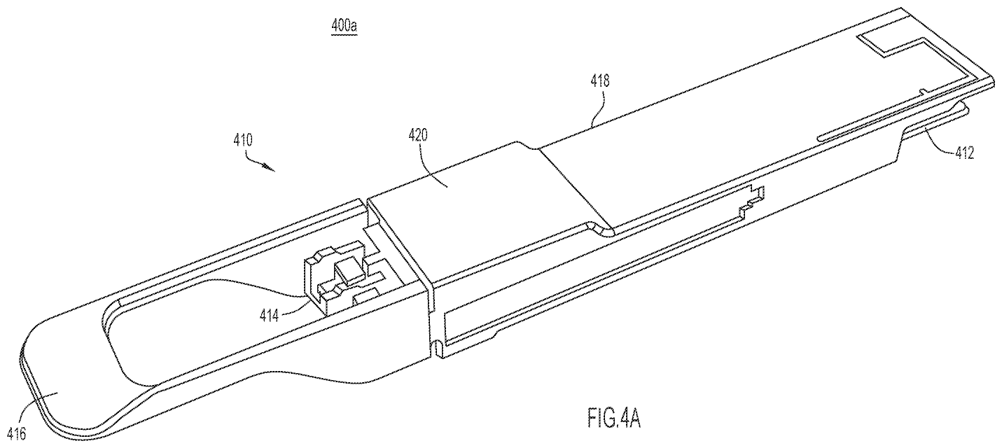

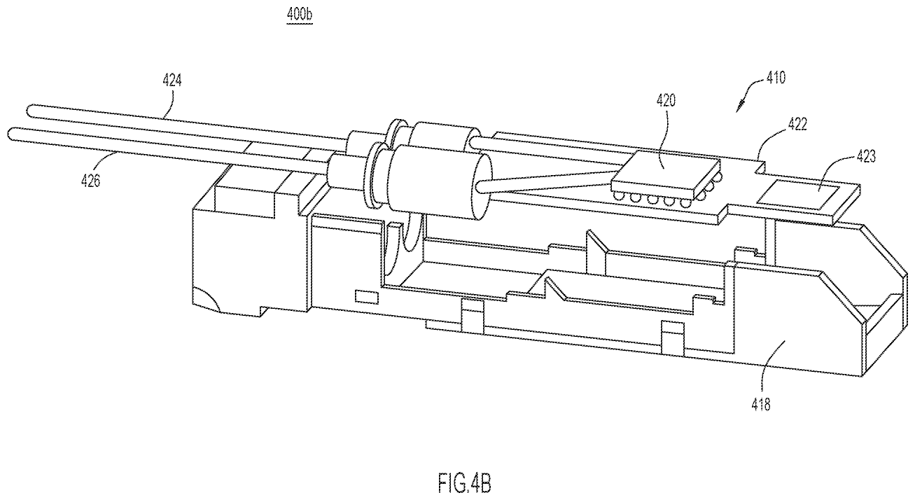

With reference now made to FIGS. 4A and 4B, depicted therein are an external view 400a and an internal view 400b, respectively, of an optical module 410 that incorporates a photonic integrated circuit 420, such as photonic integrated circuit 100 of FIG. 1, configured according to the disclosed techniques.

FIG. 4A provides a perspective view of a Quad Small Form Factor Pluggable Double Density (QSFP-DD) optical module 410. The QSFP-DD form factor of optical module 410 is just one example, and other form factors may be used without deviating from the techniques of this disclosure.

The QSFP-DD optical module 410 has an electrical interface 412 comprising a plurality of pins (not shown) for providing electrical communication between the QSFP-DD optical module 410 and a computing or network device (not shown) when the QFSP-DD optical module 410 is inserted into a port of the computing or network device that is specifically designed to receive the QSFP-DD optical module 410. The QSFP-DD optical module 410 also has an optical interface 414 for providing optical communication between the QSFP-DD optical module 410 and one or more fiber optical cables (not shown). Each fiber optical cable may include one or more optical fibers. According to the disclosed techniques, a first optical fiber may provide connectivity to an external laser source, such as external source 180 of FIG. 1. A second optical fiber may be used to output entangled photons to an external device or network, such as external device 190 of FIG. 1. Through the use of optical module 410, the photonic integrated circuits of the disclosed techniques may be incorporated into a wide array of computing devices.

The QSFP-DD optical module 410 has a handle 416 to facilitate the plugging in and removal of the QSFP-DD optical module 410 from a QSFP-DD recess of a cage of a network device. The innards of the QSFP-DD optical module 410 are encased in a shell 418. When the QSFP-DD optical module 410 is plugged into a QSFP-DD recess of a cage of a network device, the electrical interface 412 and a portion of the shell 418 enter inside the QSFP-DD recess whereas the optical interface 414, the handle 416, and a portion of the shell 418 remain outside of the QSFP-DD recess.

Turning to FIG. 4B, provided therein is an exploded internal view 400b of the internals of QSFP-DD optical module 410 showing aspects of the innards thereof. Include inside shell 418 is a circuit board 422 onto which photonic integrated circuit 420 is arranged. Also included on circuit board 422 are electrical connections 423 that permit optical module 410 to communicate with a computing device, such as a server device or personal computer device. Also illustrated in FIG. 4B are optical fibers 424 and 426. Optical fibers 424 and 426 are received in shell 418 through the optical interface 414 illustrated in FIG. 4A. Optical fiber 424 provides the laser input to photonic integrated circuit 420. Accordingly, optical fiber 424 is an example of the external source 180 that provides the laser input to input edge coupler 105 of FIG. 1. Optical fiber 426, on the other hand, provides the output from photonic integrated circuit 420, thereby providing the entangled photons for which photonic integrated circuit 420 serves as a source.

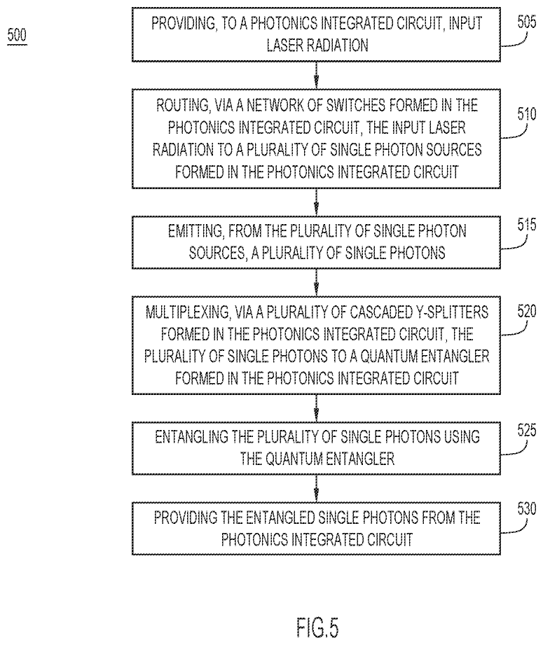

With reference now made to FIG. 5, depicted therein is a method configured to implement the on-chip sequential photon entanglement techniques of this disclosure. Flowchart 500 begins in operation 505 where input laser radiation is provided to a photonic integrated circuit. Accordingly, operation 505 may be embodied as the external source 180 of FIG. 1 providing input laser radiation to photonic integrated circuit 100 via input edge coupler 105.

Flowchart 500 continues in operation 510 in which the input laser radiation is routed to a plurality of single photon sources via a network of switches. Both the network of switches and the plurality of single photon sources are formed in the photonic integrated circuit. Specific examples of operation 510 may include the routing of laser radiation from external source 180 through the network of switches 110 to the single photon sources 120 of FIG. 1.

Next, in operation 515, the plurality of single photon sources generate a plurality of single photons, which are multiplexed by a plurality of cascaded y-splitters to a quantum entangler in operation 520. The plurality of cascaded y-splitters, like the other structures that implement the operations of flowchart 500, are formed in the photonic integrated circuit. Operations 515 and 520 may be embodied as single photon sources 120 sequentially emitting a series of photons, and cascaded y-splitters 130 multiplexing the photons to quantum entangler 140, as illustrated in FIG. 1.

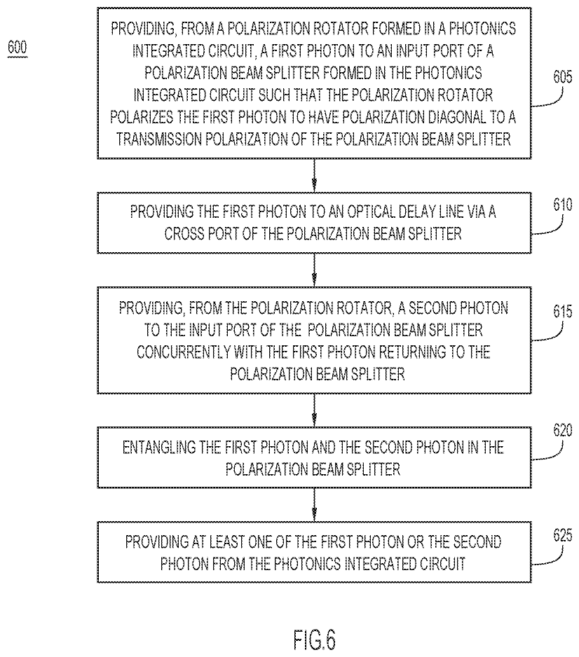

In operation 525, the plurality of single photons are entangled by the quantum entangler. Specific examples of such entanglement are described above with reference to FIG. 3 and below with reference to FIG. 6.

Finally, in operation 530, the entangled single photons are provided from the photonic integrated circuit. For example, operation 530 may be embodied as the output of entangled photons from quantum entangler 140 via output edge coupler 170 of FIG. 1.

As understood by the skilled artisan, flowchart 500 may include more or few operations without deviating from the techniques disclosed herein. For example, the operations associated with 99%-1% coupler 107 may be included in the operations of flowchart 500. Similarly, alternative techniques known to the skilled artisan may be used to excite the recited single photon sources.

Turning to FIG. 6, depicted therein is a flowchart 600 providing a method for implementing the on-chip sequential photon entanglement techniques of this disclosure. In particular, the operations included in flowchart 600 are those carried out by an on-chip quantum entangler, such as quantum entangler 140 of FIG. 1.

Flowchart 600 begins in operation 605 where a polarization rotator formed in a photonic integrated circuit provides a first photon to an input of a polarization beam splitter also formed in the photonic integrated circuit. The polarization rotator, as part of providing the photon to the polarization beam splitter, polarizes the first photon to have polarization diagonal to a transmission polarization of the polarization beam splitter. Accordingly, operation 605 may be embodied as polarization rotator 305 providing a first photon to polarization beam splitter 310, as described above with reference to FIG. 3.

Flowchart 600 continues in operation 610 in which the first photon is provide to an optical delay line via a cross port of the polarization beam splitter. Like the polarization rotator and the polarization beam splitter, the optical delay line may be formed in the photonic integrated circuit. Accordingly, operation 610 may be embodied as a first photon exiting polarization beam splitter 310 via its cross port and entering optical delay line 312, as described with reference to FIG. 3 above.

Next, in operation 615, a second photon is provided to the input port of the polarization beam splitter from the polarization rotator. More specifically, the second photon is provided to the polarization beam splitter such that it is provided concurrently with the first photon returning to the polarization beam splitter. A specific example of operation 615 may include the first and second photons currently entering polarization beam splitter 310 as described above with reference to FIG. 3. Next, the first photon and the second photon are entangled in the polarization beam splitter in operation 620, a specific example of which is also described above with reference to FIG. 3.

Finally, flowchart 600 concludes with operation 625 where at least one of the first photon or the second photon is provided from the photonic integrated circuit. Once again, a specific example of operation 625 may be found in the description of FIG. 3 above, where either the first photon or the second photon is output from the through port of the polarization beam splitter 310 entangled with the other of the first or second photon.

As with flowchart 500 of FIG. 5, flowchart 600 may include more or fewer operations without deviating from the techniques disclosed herein. For example, other examples of flowchart 600 may focus on the operations performed in the polarization beam splitter and the optical delay line without also including specific reference to the polarization rotator. Other examples of flowchart 600 may include additional operations, such as those performed by an optical delay (e.g., optical delay 315 of FIG. 3) or a polarization rotator (e.g., polarization rotator 320) included in the optical delay line.

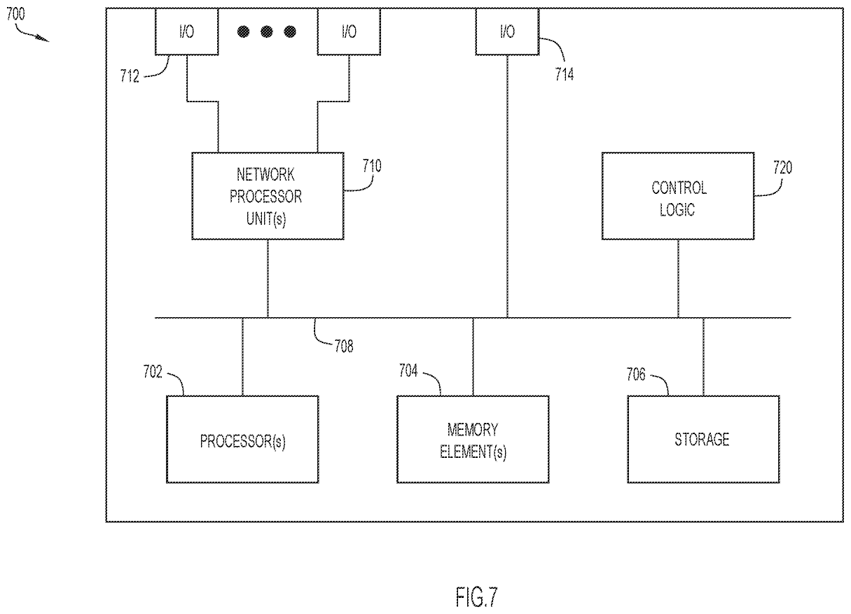

Referring to FIG. 7, FIG. 7 illustrates a hardware block diagram of a computing device 700 that may perform functions associated with operations discussed herein in connection with the techniques depicted in FIGS. 1-3, 4A-B, 5 and 6. In various embodiments, a computing device or apparatus, such as computing device 700 or any combination of computing devices 700, may be configured as any entity/entities as discussed for the techniques depicted in connection with FIGS. 1-3, 4A-B, 5 and 6 in order to perform operations of the various techniques discussed herein. According to some examples, computing device 700 may be an optical module, such as optical module 410 of FIGS. 4A and 4B. According to other examples, computing device 700 may be a computing device into which an optical module, such as optical module 410 of FIGS. 4A and 4B is plugged.

In at least one embodiment, the computing device 700 may be any apparatus that may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

According to specific examples, an optical module implementing the on-chip photon entanglement techniques of this disclosure (e.g., optical module 410 of FIGS. 4A and 4B) may interface with computing device 700 via one or more of I/O interface(s) 712 and/or I/O interface(s) 714.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In summary, provided for herein is an on-chip photonic system for generating deterministically single photons and producing sequential photon entanglements. In some aspects, the techniques described herein relate to an apparatus including: a pluggable optical module including a shell; and a photonic integrated circuit arranged within the shell, the photonic integrated circuit including: a quantum entangler; a plurality of single photon sources; and a plurality of switches.

In some aspects, the techniques described herein relate to an apparatus, wherein the plurality of switches are configured to receive laser radiation from an optical fiber connecting to the photonic integrated circuit via an optical interface of the pluggable optical module, and sequentially excite two or more single photons from the plurality of single photon sources.

In some aspects, the techniques described herein relate to an apparatus, wherein the quantum entangler is configured to sequentially obtain the two or more single photons from the plurality of single photon sources and sequentially entangle the two or more single photons.

In some aspects, the techniques described herein relate to an apparatus, wherein the quantum entangler includes a polarization rotator, a polarization beam splitter and an optical delay line.

In some aspects, the techniques described herein relate to an apparatus, wherein: the polarization rotator obtains single photons from the plurality of single photon sources and provides the single photons to the polarization beam splitter with polarization diagonal to a transmission polarization of the polarization beam splitter; the optical delay line obtains photons from the polarization beam splitter through a cross port of the polarization beam splitter and returns the photons to the polarization beam splitter via the cross port; and the polarization beam splitter entangles photons obtained concurrently from the polarization rotator and the optical delay line.

In some aspects, the techniques described herein relate to an apparatus, further including a plurality of cascaded y-splitters that multiplex single photons obtained from the plurality of single photon sources into the quantum entangler.

In some aspects, the techniques described herein relate to an apparatus, wherein each of the plurality of single photon sources includes a rare-earth-doped individual ion-addressable single photon light source.

In some aspects, the techniques described herein relate to an apparatus, wherein each rare-earth-doped individual ion-addressable single photon light source includes TiO2 or Al2O3 deposited on a Silicon waveguide and patterned into a photonic crystal.

In some aspects, the techniques described herein relate to an apparatus including: a polarization rotator formed in a photonic integrated circuit; a polarization beam splitter formed in the photonic integrated circuit; and an optical delay line formed in the photonic integrated circuit, wherein: the polarization rotator sequentially provides single photons to the polarization beam splitter with polarization diagonal to a transmission polarization of the polarization beam splitter; the optical delay line obtains the single photons from the polarization beam splitter through a cross port of the polarization beam splitter and returns the single photons to the polarization beam splitter via the cross port; and the polarization beam splitter sequentially entangles single photons obtained concurrently from the polarization rotator and the optical delay line.

In some aspects, the techniques described herein relate to an apparatus, further including a plurality of single photon light sources formed in the photonic integrated circuit that sequentially provides the single photons to the polarization rotator.

In some aspects, the techniques described herein relate to an apparatus, wherein the plurality of single photon light sources includes a plurality of rare-earth-doped individual ion-addressable single photon light sources.

In some aspects, the techniques described herein relate to an apparatus, further including a plurality of cascaded y-splitters that multiplex the single photons from the plurality of single photon light sources to the polarization rotator.

In some aspects, the techniques described herein relate to an apparatus, further including a plurality of switches formed in the photonic integrated circuit and switch laser light to sequentially excite the plurality of single photon light sources to generate the single photons.

In some aspects, the techniques described herein relate to an apparatus, further including a pluggable optical module, wherein the photonic integrated circuit is arranged within the pluggable optical module.

In some aspects, the techniques described herein relate to a method including: providing, to a photonic integrated circuit, input laser radiation; routing, via a network of switches formed in the photonic integrated circuit, the input laser radiation to a plurality of single photon sources formed in the photonic integrated circuit; emitting, from the plurality of single photon sources, a plurality of single photons; multiplexing, via a plurality of cascaded y-splitters formed in the photonic integrated circuit, the plurality of single photons to a quantum entangler formed in the photonic integrated circuit; entangling the plurality of single photons using the quantum entangler to produce entangled single photons; and providing the entangled single photons from the photonic integrated circuit.

In some aspects, the techniques described herein relate to a method, further including: providing a pluggable optical module; and arranging the photonic integrated circuit in the pluggable optical module.

In some aspects, the techniques described herein relate to a method, wherein each of the plurality of single photon sources includes a rare-earth-doped individual ion-addressable single photon light source.

In some aspects, the techniques described herein relate to a method, wherein the quantum entangler includes a polarization rotator, a polarization beam splitter and an optical delay line.

In some aspects, the techniques described herein relate to a method, wherein entangling the plurality of single photons using the quantum entangler includes: obtaining, at the polarization beam splitter from the polarization rotator, a first photon of the plurality of single photons with polarization diagonal to a transmission polarization of the polarization beam splitter; providing the first photon of the plurality of single photons to the optical delay line from the polarization beam splitter through a cross port of the polarization beam splitter; re-obtaining the first photon of the plurality of single photons at the polarization beam splitter from the optical delay line via the cross port; and entangling, at the polarization beam splitter, the first photon of the plurality of single photons with a second photon of the plurality of single photons, wherein the polarization beam splitter obtains the second photon of the plurality of single photons from the polarization rotator concurrently with re-obtaining the first photon of the plurality of single photons from the optical delay line.

In some aspects, the techniques described herein relate to a method, further including entangling the second photon of the plurality of single photons with a third photon of the plurality of single photons.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. An apparatus comprising:
a pluggable optical module comprising a shell; and
a photonic integrated circuit arranged within the shell, the photonic integrated circuit comprising:
a quantum entangler,
a plurality of single photon sources, and
a plurality of switches.

2. The apparatus of claim 1, wherein the plurality of switches are configured to receive laser radiation from an optical fiber connecting to the photonic integrated circuit via an optical interface of the pluggable optical module, and sequentially excite two or more single photons from the plurality of single photon sources.

3. The apparatus of claim 2, wherein the quantum entangler is configured to sequentially obtain the two or more single photons from the plurality of single photon sources and sequentially entangle the two or more single photons.

4. The apparatus of claim 1, wherein the quantum entangler comprises a polarization rotator, a polarization beam splitter and an optical delay line.

5. The apparatus of claim 4, wherein:
the polarization rotator obtains single photons from the plurality of single photon sources and provides the single photons to the polarization beam splitter with polarization diagonal to a transmission polarization of the polarization beam splitter;
the optical delay line obtains photons from the polarization beam splitter through a cross port of the polarization beam splitter and returns the photons to the polarization beam splitter; and
the polarization beam splitter entangles photons obtained concurrently from the polarization rotator and the optical delay line.

6. The apparatus of claim 1, further comprising a plurality of cascaded y-splitters that multiplex single photons obtained from the plurality of single photon sources into the quantum entangler.

7. The apparatus of claim 1, wherein each of the plurality of single photon sources comprises a rare-earth-doped individual ion-addressable single photon light source.

8. The apparatus of claim 1, wherein each rare-earth-doped individual ion-addressable single photon light source comprises TiO₂ or Al₂O₃ deposited on a Silicon waveguide and patterned into a photonic crystal.

9. An apparatus comprising:
a polarization rotator formed in a photonic integrated circuit;
a polarization beam splitter formed in the photonic integrated circuit; and
an optical delay line formed in the photonic integrated circuit,
wherein:
the polarization rotator sequentially provides single photons to the polarization beam splitter with polarization diagonal to a transmission polarization of the polarization beam splitter;
the optical delay line obtains the single photons from the polarization beam splitter through a cross port of the polarization beam splitter and returns the single photons to the polarization beam splitter; and
the polarization beam splitter sequentially entangles single photons obtained concurrently from the polarization rotator and the optical delay line.

10. The apparatus of claim 9, further comprising a plurality of single photon light sources formed in the photonic integrated circuit that sequentially provides the single photons to the polarization rotator.

11. The apparatus of claim 10, wherein the plurality of single photon light sources comprises a plurality of rare-earth-doped individual ion-addressable single photon light sources.

12. The apparatus of claim 10, further comprising a plurality of cascaded y-splitters that multiplex the single photons from the plurality of single photon light sources to the polarization rotator.

13. The apparatus of claim 10, further comprising a plurality of switches formed in the photonic integrated circuit and switch laser light to sequentially excite the plurality of single photon light sources to generate the single photons.

14. The apparatus of claim 9, further comprising a pluggable optical module, wherein the photonic integrated circuit is arranged within the pluggable optical module.

15. A method comprising:
providing, to a photonic integrated circuit, input laser radiation;
routing, via a network of switches formed in the photonic integrated circuit, the input laser radiation to a plurality of single photon sources formed in the photonic integrated circuit;
emitting, from the plurality of single photon sources, a plurality of single photons;
multiplexing, via a plurality of cascaded y-splitters formed in the photonic integrated circuit, the plurality of single photons to a quantum entangler formed in the photonic integrated circuit;
entangling the plurality of single photons using the quantum entangler to produce entangled single photons; and
providing the entangled single photons from the photonic integrated circuit.

16. The method of claim 15, further comprising:
providing a pluggable optical module; and
arranging the photonic integrated circuit in the pluggable optical module.

17. The method of claim 15, wherein each of the plurality of single photon sources comprises a rare-earth-doped individual ion-addressable single photon light source.

18. The method of claim 15, wherein the quantum entangler comprises a polarization rotator, a polarization beam splitter and an optical delay line.

19. The method of claim 18, wherein entangling the plurality of single photons using the quantum entangler comprises:
obtaining, at the polarization beam splitter from the polarization rotator, a first photon of the plurality of single photons with polarization diagonal to a transmission polarization of the polarization beam splitter;
providing the first photon of the plurality of single photons to the optical delay line from the polarization beam splitter through a cross port of the polarization beam splitter;
re-obtaining the first photon of the plurality of single photons at the polarization beam splitter from the optical delay line; and
entangling, at the polarization beam splitter, the first photon of the plurality of single photons with a second photon of the plurality of single photons, wherein the polarization beam splitter obtains the second photon of the plurality of single photons from the polarization rotator concurrently with re-obtaining the first photon of the plurality of single photons from the optical delay line.

20. The method of claim 19, further comprising entangling the second photon of the plurality of single photons with a third photon of the plurality of single photons.
